(19) United States
(12) Patent Application Publication
(10) Pub. No.: US 2016/0076507 A1
(43) Pub. Date: Mar. 17, 2016

(54) VENTED SPARK PLUG TUBE WITH FLAME ARRESTOR

(71) Applicant: Cummins Inc., Columbus, IN (US)

(72) Inventors: Alan C. Anderson, Columbus, IN (US); Matthew D. Misiaszek, Oneida, NY (US)

(21) Appl. No.: 14/487,636

(22) Filed: Sep. 16, 2014

(51) Int. Cl. F02P 11/00; F02P 13/00

(52) U.S. Cl. CPC F02P 11/00; F02P 13/00

(57) ABSTRACT

A venting apparatus for combustion gas is provided, comprising a port formed in a valve cover having an inlet in flow communication with an enclosed volume within a spark plug tube that receives combustion gas build up, a check valve having an inlet in flow communication with an outlet of the port, and a flame arrestor having an inlet in flow communication with an outlet of the check valve, and a plurality of outlets. Combustion gas in the volume is vented through the check valve and the flame arrestor but a flame from ignition of the combustion gas in the volume is prevented from propagating through the flame arrestor to an outside environment.

### TECHNICAL FIELD

The present invention relates generally to ignition assemblies, and more specifically to configurations for venting combustion gas that passes a spark plug in a manner that prevents a flame from propagating to an outside environment.

### BACKGROUND

Spark plugs mounted to a cylinder head do not prevent all gases from the combustion chamber from passing through the spark plug/cylinder head interface. When spark plugs are mounted within a spark plug tube, liquids may condense out from built up combustion gas in the tube and degrade the performance of the spark plug. Thus, in certain applications the built up combustion gas is permitted to vent through a metal-to-metal interface between the coil and the valve cover. This interface, however, may permit ingress of liquids from the outside environment into the spark plug tube, thereby causes performance degradation of the spark plug.

Consequently, it is desirable to provide a venting configuration for built up combustion gas in the spark plug tube that also permits prevention of liquid ingress from the outside environment into the spark plug tube. It is further desirable to vent the combustion gas in a manner that prevents a flame resulting from ignition of the gas within the spark plug tube from propagating to the outside environment, thereby permitting use of the engine in hazardous areas.

### SUMMARY

According to one embodiment, the present disclosure provides a venting apparatus for combustion gas, comprising a port formed in a valve cover having an outlet and an inlet in flow communication with an enclosed volume within a spark plug tube that receives combustion gas build up, a check valve having an inlet in flow communication with the outlet of the port and an outlet, and a flame arrestor having an inlet in flow communication with the check valve outlet, and a plurality of outlets. Combustion gas in the volume is vented through the check valve and the flame arrestor but a flame from ignition of the combustion gas in the volume is prevented from propagating through the flame arrestor to an outside environment. In one aspect of this embodiment, the port includes a first drilling extending from an outer surface of the valve cover to the inlet adjacent an upper opening of the spark plug tube, and a second drilling extending from the outlet at an inner surface of the valve cover to the first drilling. A variant of this aspect further includes a plug disposed in the first drilling to prevent gas flow through the outer surface of the valve cover. In another variant, the second drilling includes a threaded bore extending into the valve cover from the outlet, the threaded bore configured to receive a threaded end of the check valve. In another aspect of this embodiment, the flame arrestor is a sintered metal flame arrestor. In another aspect, the flame arrestor is disposed in an internal volume of the valve cover. In another aspect of this embodiment, the outlet of the port is disposed on an outer surface of the valve cover. Another aspect further includes a weather seal between an outer surface of the valve cover and a surface of an ignition coil.

In another embodiment of the present disclosure, a venting apparatus for combustion gas is provided, comprising a coupling mounted to a spark plug tube, the coupling having an outlet and an inlet in flow communication with an enclosed volume within the spark plug tube that receives combustion gas build up, a check valve having an inlet in flow communication with the outlet of the coupling and an outlet, and a flame arrestor having an inlet in flow communication with the check valve outlet, and a plurality of outlets. Combustion gas in the volume is vented through the check valve and the flame arrestor but a flame from ignition of the combustion gas in the volume is prevented from propagating through the flame arrestor to an outside environment. In one aspect of this embodiment, the flame arrestor is a sintered metal flame arrestor. Another aspect further includes a boss mounted to an outer wall of the spark plug tube, the coupling being mounted to the boss. In another aspect, the flame arrestor is mounted within an internal volume of the valve cover. Yet another aspect further includes a weather seal between an outer surface of the valve cover and a surface of an ignition coil.

In yet another embodiment of the present disclosure, a mounting configuration is provided, comprising a spark plug tube, a spark plug extender configured to couple to a spark plug; the spark plug extender being disposed in the spark plug tube thereby defining a volume between an outer surface of the spark plug extender and an inner surface of the spark plug tube, the volume receiving combustion gas that leaks past the spark plug, a check valve having an inlet in fluid communication with the volume and an outlet, and a flame arrestor coupled to the outlet of the check valve, the flame arrestor having a plurality of outlets configured to permit combustion gas to pass through the outlets but to prevent a flame from propagating through the outlets. Combustion gas in the volume is vented through the check valve and the flame arrestor such that when the combustion gas is ignited in the volume, the resulting flame will not propagate to an environment surrounding the flame arrestor. One aspect of this embodiment further includes a port formed in a valve cover having an outlet and an inlet in flow communication with the volume. In a variant of this aspect, the port includes a first drilling extending from an outer surface of the valve cover to the port inlet adjacent an upper opening of the spark plug tube, and a second drilling extending from the outlet of the port at an inner surface of the valve cover to the first drilling. Another variant of this aspect further includes a plug disposed in the first drilling to prevent gas flow through the outer surface of the valve cover. In another variant, the second drilling includes a threaded bore extending into the valve cover from the outlet, the threaded bore configured to receive a threaded end of the check valve. In another aspect of this embodiment, the flame arrestor is a sintered metal flame arrestor. In another aspect, the flame arrestor is disposed in an internal volume of the valve cover. In still another aspect, the outlet of the port is disposed on an outer surface of the valve cover. Another aspect further includes a weather seal between an outer surface of the valve cover and a surface of an ignition coil. Another aspect includes a coupling mounted to the spark plug tube, the coupling having an outlet and an inlet in flow communication with the volume. Yet another aspect includes a weather seal between an outer surface of the valve cover and a surface of an ignition coil.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a conceptual side view, partly in section, of a prior art shielded ignition assembly mounted to an engine;

FIG. 2 is a side sectional view of an ignition assembly according to one embodiment of the present disclosure; and

FIG. 3 is a side sectional view of an ignition assembly according to another embodiment of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

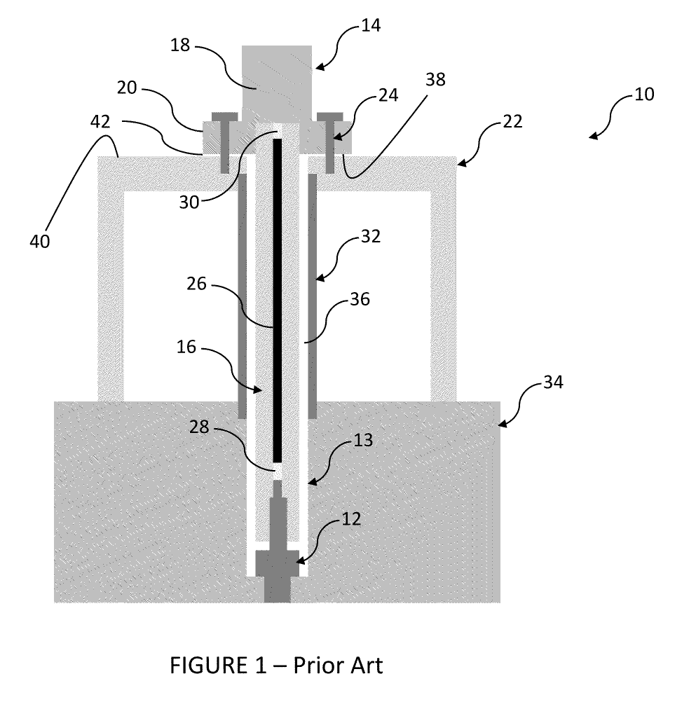

FIG. 1 depicts a prior art shielded ignition assembly for a spark ignited engine. Assembly 10 generally includes a spark plug 12 mounted within a spark plug cavity 13, a coil 14, and a shielded spark plug extender 16 extending between and connecting spark plug 12 to coil 14. Coil 14 includes a coil body 18 and a flange 20 for mounting coil 14 to valve cover 22 using fasteners 24. Extender 16 includes a center conductor 26, a spring connector 28 connected to conductor 26 and providing an electrical connection to spark plug 12, and a spring connector 30 connected to conductor 26 and providing an electrical connection to coil 14. Extender 16 is mounted within a spark plug tube 32 that extends between cylinder head 34 and valve cover 22.

As depicted in FIG. 1, spark plug 12 is mounted within cylinder head 34, typically near the center of the cylinder bore (not shown). Access to spark plug 12 is typically gained through the top of valve cover 22 (by removing coil 14 and extender 16). Spark plug tube 32 prevents engine lube oil and/or coolant within valve cover 22 from entering the spark plug cavity 13 and corroding or contaminating the high voltage connection between spark plug 12 and conductor 26 through spring connector 28. Thus, it is desirable that tube 32 provide a leak proof barrier around extender 16.

It is known that essentially all spark plugs 12 leak some amount of combustion gas through their seals. In other words, as the fuel/air mixture in the cylinder is ignited and combusts, some portion of the gas is forced by the pressure of the combustion up through the connection between spark plug 12 and cylinder head 34. This combustion gas enters the gap 36 formed between extender 16 and tube 32. As the combustion gas cools in gap 36, liquids may condense out of the gas and cause corrosion of the high voltage connection between spark plug 12 and conductor 26. Degradation of the electrical connection to spark plug 12, whether as a result of ingress of liquids through tube 32 or combustion gas around spark plug 12, eventually lowers the voltage capacity of the system and eventually results in poor engine performance.

Assembly 10 of FIG. 1 partially addresses the above-described problem. More specifically, in assembly 10 as combustion gas builds up in gap 36 it is vented to atmosphere through the interface between coil 14 and valve cover 22. Flange 20 of coil 14 has a lower surface 38 that contacts an upper surface 40 of valve cover 22. This metal to metal interface leaves a small gap 42 even if coil 14 is tightly attached to valve cover 22 by fasteners 24. When the pressure of gas within gap 36 is sufficiently high, the gas will escape to atmosphere through gap 42. While this configuration reduces the risk that liquids will condense out of combustion gas in gap 36 and contaminate spark plug chamber 13, it presents a risk that liquids will pass through gap 42 and collect within spark plug chamber 13. For example, the process of servicing an engine includes cleaning the engine, typically by power-washing the engine using very high pressure water. Such water may pass through gap 42 and contaminate spark plug chamber 13.

One way to reduce the risk of ingress of liquids through gap 42 is to use a weather seal or gasket between flange 20 of coil 14 and valve cover 22. Such a weather seal would, however, also prevent combustion gas within tube 32 from venting to atmosphere. Consequently, combustion gas pressure would build up in tube 32 until an equilibrium pressure is established between gap 36 and the main combustion chamber. Upon cooling during engine shut down, liquids could then condense out of the pressurized gas in gap 36 and potentially cause corrosion to spark plug 12 and/or extender 16.

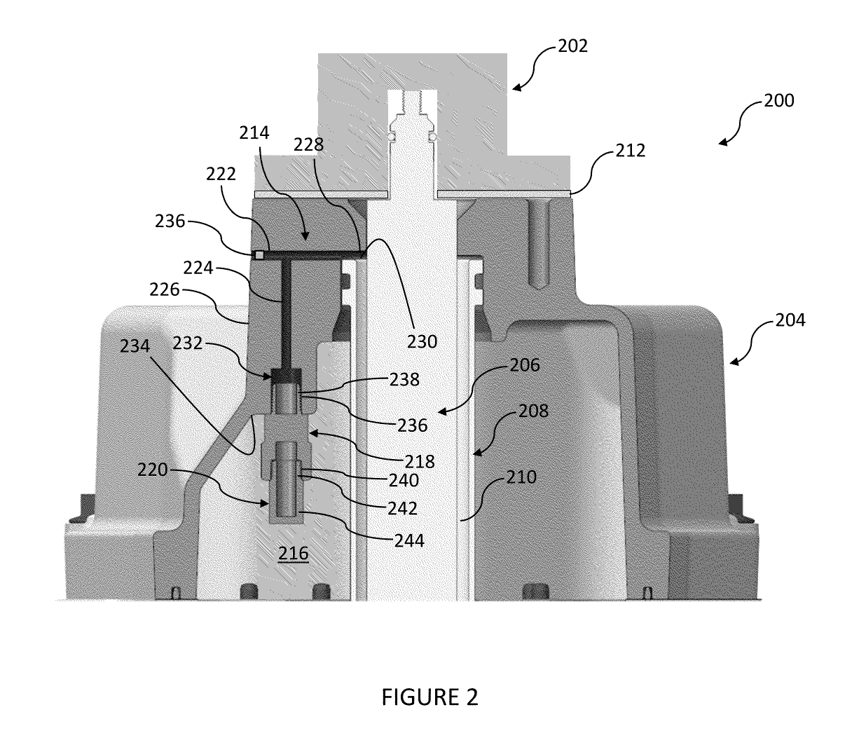

Referring now to FIG. 2, the present disclosure provides an assembly wherein a weather seal prevents ingress of liquids and combustion gas is safely vented in a manner that permits use of the engine in a hazardous area. In hazardous areas where the engine is surrounded by one or more potentially explosive gases, certain governmental regulations must be met to prevent ignition of the surrounding gas. One requirement is that the engine cannot present an ignition source for the surrounding gas. One potential source of a flame is from combustion of accumulated combustion gas in the spark plug tube. While such combustion is permissible in hazardous area applications, the flame cannot propagate through any venting passage of the gas to the surrounding gas.

The configuration 200 depicted in FIG. 2 is similar to that of FIG. 1 in that a coil 202 is mounted to a valve cover 204 and electrically connected to a spark plug extender 206 situated within a spark plug tube 208, thereby defining a gap 210 between extender 206 and tube 208. While the spark plug and cylinder head are not shown in FIG. 2, it should be understood that combustion gas that passes the spark plug enters and accumulates in gap 210. Configuration 200 also includes a weather seal 212 between coil 202 and valve cover 204. As explained above, such a weather seal, which may be formed of, for example, an elastomeric material like an O-ring or gasket, reduces the risk of liquid ingress into tube 208 (e.g., from power-washing), but it also prevents combustion gas in gap 208 from venting to atmosphere.

To permit venting of combustion gas, configuration 200 includes a port 214 formed in valve cover 204 in flow communication with gap 210 and an internal volume 216 of valve cover 204, a check valve 218 in flow communication with port 214, and a flame arrestor 220 in flow communication with check valve 218. More specifically, port 214 includes a first drilling 222 and a second drilling 224. First drilling 222 extends from an outer surface 226 of valve cover 204 to an inlet 228 of port 214 adjacent an upper opening 230 of spark plug tube 208. Second drilling 224 extends from an outlet 232 of port 214 disposed at an inner surface 234 of valve cover 204 to first drilling 222. First drilling 222 includes a plug 236 which is inserted into first drilling 222 in the manner shown to prevent gas from within gap 210 from flowing though first drilling 222 to the outside environment.

Outlet 232 includes a threaded bore 236 that extends from inner surface 234 into valve cover 204. Check valve 218 includes a threaded inlet end 238 configured to thread into outlet 232 and a threaded outlet end 240 configured to receive a threaded end 242 of flame arrestor 220. Check valve 218 may be any suitable one-way valve that permits gas flow from inlet end 238 to outlet end 240, but prevents gas flow from outlet end 240 to inlet end 238. In addition to threaded end 242, flame arrestor 220 includes a sintered metal body 244 which, as is known in the art, permits gas flow through body 244 but prevents a flame from penetrating body 244.

In operation, as combustion gas leaks past the spark plug into tube 208, it passes through upper opening 230 of tube 208 into inlet 228 of port 214. The gas then passes through first drilling and second drilling, and out outlet 232 of port 214. The gas passes through check valve 218 and flame arrestor 220 into internal volume 216 of valve cover 204. If the gas within tube 208 combusts, any flame is prevented from propagating to the environment outside the engine. Thus, such a configuration may be used in hazardous areas.

In an alternate embodiment, second drilling 224 and plug 236 are omitted, and outlet 232 is formed through outer surface 226 of valve cover 204. Check valve 218 and flame arrestor 220 are mounted to outlet 232 in the manner described above. In this embodiment, check valve 218 and flame arrestor 220 are situated outside of valve cover 204. This embodiment may nonetheless still be used in hazardous areas as flame arrestor 220 prevents propagation of flame to the gas surrounding the engine.

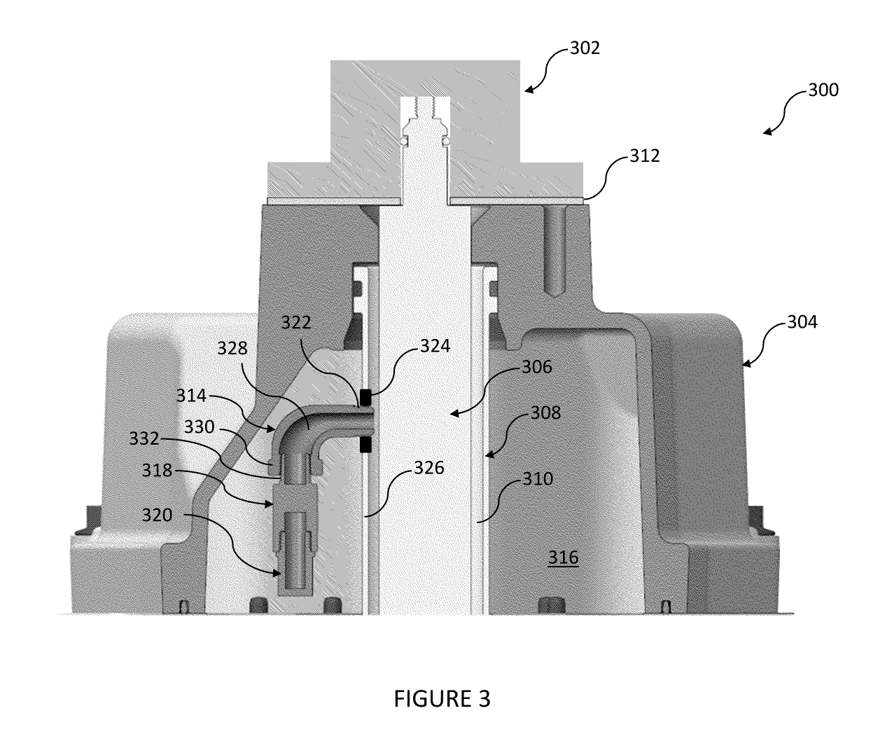

Another embodiment of the present disclosure is shown in FIG. 3. Configuration 300 depicted in FIG. 3 is similar to that of FIG. 2 in that a coil 302 is mounted to a valve cover 304 and electrically connected to a spark plug extender 306 situated within a spark plug tube 308, thereby defining a gap 310 between extender 306 and tube 308. While the spark plug and cylinder head are not shown in FIG. 3, it should be understood that combustion gas that passes the spark plug enters and accumulates in gap 310. Configuration 300 also includes a weather seal 312 between coil 302 and valve cover 304.

To permit venting of combustion gas, configuration 300 includes a coupling 314 mounted to tube 308 in flow communication with gap 310 and an internal volume 316 of valve cover 304, a check valve 318 in flow communication with coupling 314, and a flame arrestor 320 in flow communication with check valve 318. More specifically, coupling 314 includes an inlet end 322 configured to be threaded into a boss 324 mounted to an outer wall 326 of tube 308, an inner passage 328, and an outlet end 330 configured to receive a threaded end 332 of check valve 318. Check valve 318 and flame arrestor 320 are the same as those described above with reference to FIG. 2.

In operation, as combustion gas leaks past the spark plug into tube 308, it passes through outer wall 326 of tube 308 into inlet end 322 of coupling 314. The gas then passes through passage 328 and out outlet end 330 of coupling 314. The gas passes through check valve 318 and flame arrestor 320 into internal volume 316 of valve cover 304. If the gas within tube 308 combusts, any flame is prevented from propagating to the environment outside the engine. Thus, such a configuration may be used in hazardous areas.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A venting apparatus for combustion gas, comprising:
a port formed in a valve cover having an outlet and an inlet in flow communication with an enclosed volume within a spark plug tube that receives combustion gas build up;
a check valve having an inlet in flow communication with the outlet of the port and an outlet; and
a flame arrestor having an inlet in flow communication with the check valve outlet, and a plurality of outlets;
wherein combustion gas in the volume is vented through the check valve and the flame arrestor but a flame from ignition of the combustion gas in the volume is prevented from propagating through the flame arrestor to an outside environment.

2. The venting apparatus of claim 1, wherein the port includes a first drilling extending from an outer surface of the valve cover to the inlet adjacent an upper opening of the spark plug tube, and a second drilling extending from the outlet at an inner surface of the valve cover to the first drilling.

3. The venting apparatus of claim 2, further including a plug disposed in the first drilling to prevent gas flow through the outer surface of the valve cover.

4. The venting apparatus of claim 2, wherein the second drilling includes a threaded bore extending into the valve cover from the outlet, the threaded bore configured to receive a threaded end of the check valve.

5. The venting apparatus of claim 1, wherein the flame arrestor is a sintered metal flame arrestor.

6. The venting apparatus of claim 1, wherein the flame arrestor is disposed in an internal volume of the valve cover.

7. The venting apparatus of claim 1, wherein the outlet of the port is disposed on an outer surface of the valve cover.

8. The venting apparatus of claim 1, further including a weather seal between an outer surface of the valve cover and a surface of an ignition coil.

9. A venting apparatus for combustion gas, comprising:
a coupling mounted to a spark plug tube, the coupling having an outlet and an inlet in flow communication with an enclosed volume within the spark plug tube that receives combustion gas build up;
a check valve having an inlet in flow communication with the outlet of the coupling and an outlet; and
a flame arrestor having an inlet in flow communication with the check valve outlet, and a plurality of outlets;
wherein combustion gas in the volume is vented through the check valve and the flame arrestor but a flame from ignition of the combustion gas in the volume is prevented from propagating through the flame arrestor to an outside environment.

10. The venting apparatus of claim 9, wherein the flame arrestor is a sintered metal flame arrestor.

11. The venting apparatus of claim 9, further including a boss mounted to an outer wall of the spark plug tube, the coupling being mounted to the boss.

12. The venting apparatus of claim 9, wherein the flame arrestor is mounted within an internal volume of the valve cover.

13. The venting apparatus of claim 9, further including a weather seal between an outer surface of the valve cover and a surface of an ignition coil.

14. A mounting configuration, comprising:
a spark plug tube;
a spark plug extender configured to couple to a spark plug; the spark plug extender being disposed in the spark plug tube thereby defining a volume between an outer surface of the spark plug extender and an inner surface of the spark plug tube, the volume receiving combustion gas that leaks past the spark plug;
a check valve having an inlet in fluid communication with the volume and an outlet; and
a flame arrestor coupled to the outlet of the check valve, the flame arrestor having a plurality of outlets configured to permit combustion gas to pass through the outlets but to prevent a flame from propagating through the outlets;
wherein combustion gas in the volume is vented through the check valve and the flame arrestor such that when the combustion gas is ignited in the volume, the resulting flame will not propagate to an environment surrounding the flame arrestor.

15. The mounting configuration of claim 14, further including a port formed in a valve cover having an outlet and an inlet in flow communication with the volume.

16. The mounting configuration of claim 15, wherein the port includes a first drilling extending from an outer surface of the valve cover to the port inlet adjacent an upper opening of the spark plug tube, and a second drilling extending from the outlet of the port at an inner surface of the valve cover to the first drilling.

17. The mounting configuration of claim 16, further including a plug disposed in the first drilling to prevent gas flow through the outer surface of the valve cover.

18. The mounting configuration of claim 16, wherein the second drilling includes a threaded bore extending into the valve cover from the outlet, the threaded bore configured to receive a threaded end of the check valve.

19. The mounting configuration of claim 14, wherein the flame arrestor is a sintered metal flame arrestor.

20. The mounting configuration of claim 15, wherein the flame arrestor is disposed in an internal volume of the valve cover.

21. The mounting configuration of claim 15, wherein the outlet of the port is disposed on an outer surface of the valve cover.

22. The mounting configuration of claim 15, further including a weather seal between an outer surface of the valve cover and a surface of an ignition coil.

23. The mounting configuration of claim 14, further including a coupling mounted to the spark plug tube, the coupling having an outlet and an inlet in flow communication with the volume.

24. The mounting configuration of claim 15, further including a weather seal between an outer surface of the valve cover and a surface of an ignition coil.
